(19) United States
(12) Patent Application Publication
(10) Pub. No.: US 2026/0246772 A1
(43) Pub. Date: Aug. 20, 2026

(54) SYSTEM AND METHOD FOR DIGITAL AUTHENTICATION DURING A VOICE CALL SESSION

(71) Applicant: The Toronto-Dominion Bank, Toronto (CA)

(72) Inventor: Axel Smith SCHON, Toronto (CA)

(73) Assignee: The Toronto-Dominion Bank, Toronto (CA)

(21) Appl. No.: 19/058,141

(22) Filed: Feb. 20, 2025

(51) Int. Cl. H04L 9/40

(52) U.S. Cl. CPC H04L 63/0838; H04L 63/18

(57) ABSTRACT

A computer system comprises at least one processor; a communications module coupled to the at least one processor; and a memory coupled to the at least one processor, the memory storing instructions that, when executed, configure the at least one processor to obtain a one-time password associated with a resource account and detect an initiation of a voice call session; send, to a first computing device associated with the initiation of the voice call session, a signal causing the first computing device to display the one-time password; and send, via the communications module to a second computing device associated with the resource account, data relating to the one-time password. One or more of the steps may be performed using artificial intelligence.

### TECHNICAL FIELD

The present application relates to systems and methods for digital authentication during a voice call session.

### BACKGROUND

Oftentimes fraudsters impersonate legitimate entities during communications with customers or account holders. Fraudsters often utilize deceptive techniques, such as spoofed phone numbers, emails, or messaging platforms, to masquerade as a trusted entity. Victims, unaware of the impersonation, readily provide sensitive information such as account credentials, personal details, or authorization codes, leading to unauthorized access and fraudulent activities.

Existing solutions rely heavily on user vigilance or basic authentication methods, such as caller ID or email headers, which can be easily bypassed by fraudsters. More advanced systems often implement robust verification methods; however, these are computationally inefficient, requiring significant processing power and latency, which limits scalability and accessibility for widespread deployment. The computational overhead of these systems also poses challenges for real-time use, making them impractical for seamless, large-scale protection against impersonation fraud.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a simplified schematic diagram showing components of an example computer device;

FIG. 3 is a high-level schematic diagram of an example computer system;

FIG. 4 shows a simplified organization of software components stored in a memory of the computer system of FIG. 3;

FIG. 5 shows, in flowchart form, an example method for authenticating a voice call initiator during a voice call session;

FIG. 6 shows, in flowchart form, an example method for obtaining a one-time password during a voice call session;

FIG. 7 shows, in flowchart form, an example method for storing and deleting a one-time password;

FIG. 8 shows, in flowchart form, another example method for storing and deleting a one-time password;

FIG. 9 shows, in flowchart form, an example method for displaying a one-time password on a computing device via a mobile application installed thereon;

FIG. 10 shows an example computing device, associated with initiating a voice call session, displaying a one-time password with respect to the voice call session;

FIG. 11 shows an example notification displayed within a notification center on a display screen of a computing device;

FIG. 12A shows another example notification displayed within a notification center on a display screen of a computing device;

FIG. 12B shows an example one-time password displayed within an application installed on a computing device; and

FIG. 13 shows an example notification displayed within a messaging application installed on a computing device.

Like reference numerals are used in the drawings to denote like elements and features.

### DETAILED DESCRIPTION OF VARIOUS EMBODIMENTS

In an aspect, the present application describes a computer system comprising at least one processor; a communications module coupled to the at least one processor; and a memory coupled to the at least one processor. The memory stores instructions that, when executed, configure the at least one processor to: obtain a one-time password associated with a resource account and detect an initiation of a voice call session; send, to a first computing device associated with the initiation of the voice call session, a signal causing the first computing device to display the one-time password; and send, via the communications module to a second computing device associated with the resource account, data relating to the one-time password.

In some implementations, the instructions, when executed, further configure the at least one processor to: receive, via the communications module and from the second computing device, a signal confirming authentication of the first computing device during the voice call session using the one-time password; and responsive to receiving the signal confirming the authentication, send, to the first computing device, a signal causing the first computing device to remove the one-time password from display.

In some implementations, the instructions, when executed, further configure the at least one processor to: analyze voice call session data of the voice call session to determine an identifier associated with the second computing device; consult a database to identify the resource account at least using the identifier; and in response to identifying the resource account, obtain the one-time password.

In some implementations, the instructions, when executed, further configure the at least one processor to: determine that the second computing device has answered the voice call session; and responsive to determining that the second computing device has answered the voice call session, send, via the communications module and to the first computing device, the signal causing the first computing device to display the one-time password.

In some implementations, the instructions, when executed, further configure the at least one processor to: responsive to detecting the initiation of the voice call session, generate the one-time password; and store the one-time password in a database in association with the resource account.

In some implementations, the instructions, when executed, further configure the at least one processor to: send, via the communications module and to the second computing device, a signal causing the second computing device to display a notification that includes a selectable interface element for indicating confirmation of the one-time password during the voice call session; receive, via the communication module and from the second computing device, a signal indicating selection of the selectable interface element for indicating confirmation of the one-time password during the voice call session; in response to receiving the signal indicating selection of the selectable interface element for indicating confirmation of the one-time password during the voice call session, send, via to the first computing device, a signal causing the first computing device to remove the one-time password from display; and delete the one-time password from the database.

In some implementations, the instructions, when executed, further configure the at least one processor to: delete the one-time password in response to expiration thereof; generate a subsequent one-time password; and store the subsequent one-time password in the database.

In some implementations, when sending, to the second computer device, the data relating to the one-time password, the instructions, when executed, further configure the at least one processor to: determine that the second computing device has answered the voice call session; and responsive to determining that the second computing device has answered the voice call session, send, via the communications module and to the second computing device, a signal causing the second computing device to display the data relating to the one-time password.

In some implementations, the instructions, when executed, further configure the at least one processor to: determine that the second computing device has answered the voice call session; and responsive to determining that the second computing device has answered the voice call session, send, via the communications module and to the second computing device, a signal causing the second computing device to display a notification that includes a request to authenticate within a particular mobile application resident on the second computing device.

In some implementations, the instructions, when executed, further configure the at least one processor to: determine that the second computing device has authenticated within the particular mobile application; and send, via the communications module and to the second computing device, a signal causing the second computing device to display the one-time password within the particular mobile application.

In some implementations, the signal causing the second computing device to display the one-time password within the particular mobile application includes a push notification.

In some implementations, the instructions, when executed, further configure the at least one processor to: receive, via the communications module and from the second computing device, authentication data; and analyze the authentication data to identify the resource account.

In some implementations, at least one of obtaining the one-time password associated with the resource account, sending the signal causing the first computing device to display the one-time password, or sending data relating to the one-time password may be performed using artificial intelligence

In another aspect, the present application describes a computer-implemented method. The method comprises: obtaining a one-time password associated with a resource account and detecting an initiation of a voice call session; sending, to a first computing device associated with the initiation of the voice call session, a signal causing the first computing device to display the one-time password; and sending, via a communications module to a second computing device associated with the resource account, data relating to the one-time password.

In some implementations, the method further comprises receiving, via the communications module and from the second computing device, a signal confirming authentication of the first computing device during the voice call session using the one-time password; and responsive to receiving the signal confirming the authentication, sending, to the first computing device, a signal causing the first computing device to remove the one-time password from display.

In some implementations, the method further comprises: analyzing voice call session data of the voice call session to determine an identifier associated with the second computing device; consulting a database to identify the resource account at least using the identifier; and in response to identifying the resource account, obtaining the one-time password.

In some implementations, the method further comprises: determining that the second computing device has answered the voice call session; and responsive to determining that the second computing device has answered the voice call session, sending, via the communications module and to the first computing device, the signal causing the first computing device to display the one-time password.

In some implementations, the method further comprises responsive to detecting the initiation of the voice call session, generating the one-time password; and storing the one-time password in a database in association with the resource account.

In some implementations, the method further comprises: sending, via the communications module and to the second computing device, a signal causing the second computing device to display a notification that includes a selectable interface element for indicating confirmation of the one-time password during the voice call session; receiving, via the communication module and from the second computing device, a signal indicating selection of the selectable interface element for indicating confirmation of the one-time password during the voice call session; in response to receiving the signal indicating selection of the selectable interface element for indicating confirmation of the one-time password during the voice call session, sending, via to the first computing device, a signal causing the first computing device to remove the one-time password from display; and deleting the one-time password from the database.

In some implementations, when sending, to the second computer device, the data relating to the one-time password, the method further comprises: determining that the second computing device has answered the voice call session; and responsive to determining that the second computing device has answered the voice call session, sending, via the communications module and to the second computing device, a signal causing the second computing device to display the data relating to the one-time password.

In another aspect, the present application describes a non-transitory computer-readable medium storing instructions. The instructions, when executed by at least one processor, cause the at least one processor to: obtain a one-time password associated with a resource account and detect an initiation of a voice call session; send, to a first computing device associated with the initiation of the voice call session, a signal causing the first computing device to display the one-time password; and send, via a communications module to a second computing device associated with the resource account, data relating to the one-time password.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

In conventional voice call session authentication, the calling party typically requests the answering party to authenticate themselves by responding to personal questions or other verification methods. However, such approaches often leave the calling party's identity unchecked, increasing the risk of fraudulent activities. At least some of the embodiments described herein address this limitation by enabling the answering party to authenticate the calling party. This reversal of conventional roles introduces an additional layer of security, significantly mitigating fraud risks and enhancing trust during voice call interactions.

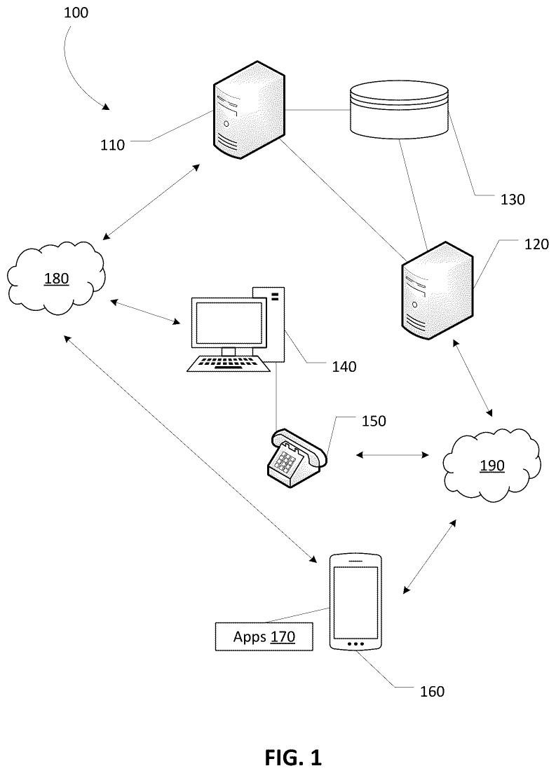

FIG. 1 is a schematic operation diagram illustrating an operating environment of an example embodiment. As shown, the system 100 includes a computer system 110 (illustrated as a server), a first computing device 140 (illustrated as a desktop computer), and a second computing device 160 (illustrated as a mobile device) coupled to one another through a network 180, which may include a public network such as the Internet and/or a private network. FIG. 1 further shows a telecommunications network 190 coupling a telephony system 120, a telephone device 150, and the second computing device 160. The telephone device 150 may be coupled to or associated with the first computing device 140. The telephony system 120 may be coupled to or associated with the computer system 110. The computer system 110, the telephony system 120, the first computing device 140, and the second computing device 160 may be in geographically disparate locations. Put differently, the computer system 110, the telephony system 120, the first computing device 140, and the second computing device 160 may be located remote from one another.

The computer system 110 may be coupled to the telephony system 120 via, for example, direct hardware interfaces, middleware, application programming interfaces (APIs), a network such as the network 180, or a combination thereof. The telephony system 120 may manage or operate a voice communication or data transmission over a network such as the telecommunications networks 190. Specifically, the telephony system 120 may, without limitation, manage voice calls inbound to and outbound from telephone devices such as the telephone device 150, route voice calls, monitor and log call data and call metadata, and encrypt call data. The telephony system 120 may manage or operate a public switched telephone network (PSTN) telephony system, a private branch exchange (PBX) telephony system, a voice over Internet protocol (VoIP) telephony system, or a cloud telephony system. Computer-telephony integration (CTI) technology may be used to integrate the telephony system 120, or its components such as applications, software, and hardware, with the computer system 110, or its components such as applications, software, and hardware.

It should be appreciated that FIG. 1 illustrates a non-limiting example embodiment. In some embodiments, the computer system 110 and the telephony system 120 may be components of the same computer system or server.

The computer system 110 and/or the telephony system 120 may maintain a database 130 that includes various data records. For example, the computer system 110 may be a financial institution server which may maintain customer bank accounts. In this example, a data record may, for example, reflect an amount of value stored in a particular account associated with a user. The amount of value may include a quantity of currency.

The database 130 may include data records for a plurality of resource accounts and at least some of the data records may define a quantity of resources associated with an account holder. For example, an account holder associated with the second computing device 160 may be associated with one or more resource accounts having one or more data records in the database 130. The data records may reflect a quantity of resources that are available to the account holder. Such resources may include owned resources and, in at least some embodiments, borrowed resources (e.g., resources available on credit). The quantity of resources that are available to or associated with an account holder may be reflected by a balance defined in an associated data record such as, for example, a bank balance. The resource accounts may include, for example, a chequing account, a savings account, a borrowing account such as for example a line of credit account, a credit card account, a loyalty point account, etc. As such, at least some of the data records may define a chequing account balance, a savings account balance, a line of credit account balance, a credit card account balance, a loyalty point account balance, etc.

The database 130 may additionally include data records for storing identity data of account holders or customers. The identity data may include, for example, a name, an email address, a social security number, an address, a phone number, etc. of the account holder. The identity data may include identity data previously-obtained to fulfill know-your-customer (KYC) requirements. The database 130 may store additional information such as for example an indication that one or more computing devices or mobile devices have passkeys installed thereon. The database may additionally store one or more passkeys that may be used to authenticate an account holder or computing device.

In some embodiments, the database 130 may store telephony event data. For example, the telephony system 120 may log, without limitation, call metadata (e.g. caller ID, call time, call duration, and call direction), call audio recordings, touch-tone (DTMF) inputs, and call status events to the database 130. The computer system 110 and/or the telephony system 120 may monitor telephony event data in the database 130. For example, as will be described herein, responsive to detecting a voice call session initiated from the first computing device 140 to the second computing device 160, the computer system 110 may send data relating to a one-time password to the first computing device 140 and the second computing device 160.

The first computing device 140 may be a computer system that may communicate with the computer system 110. The first computing device 140 may interact with the computer system 110 to perform tasks such as for example managing account holder data and executing authentication procedures.

The telephone device 150 may communicate with the telephony system 120. As will be described, the telephony system 120 may manage voice call sessions between the first computing device 140 and the second computing device 160.

It should be appreciated that FIG. 1 illustrates a non-limiting example embodiment. In some embodiments, the first computing device 140 and the telephone device 150 may be part of the same device. That is to say, in some embodiments, the first computing device 140 may communicate with both the computer system 110, via the network 180, and the telephony system 120, via the telecommunications network 190.

The second computing device 160 may take a variety of forms including, for example, a mobile communication device such as a smartphone, a tablet computer, a wearable computer (such as a head-mounted display or smartwatch), a laptop or desktop computer, or a computing device of another type. The second computing device 160 may store software instructions that cause the second computing device 160 to establish communications with the computer system 110, the telephony system 120, the first computing device 140, and/or the telephone device 150 via the network 180 and/or the telecommunications network 190. In some instances, the second computing device 160 may execute or perform these communications using applications such as apps 170 installed thereon.

The second computing device 160 may be adapted to present a graphical user interface (GUI) that allows for communication with the computer system 110, the telephony system 120, and/or the first computing device 140. For example, the second computing device 160 may be adapted to receive, from the computer system 110, a signal that causes the second computing device 160 to display a GUI associated with one of the apps 170.

The network 180 may be a computer network. In some embodiments, the network 180 may be an internetwork such as may be formed of one or more interconnected computer networks. For example, the network 180 may be or may include an Ethernet network, an asynchronous transfer mode (ATM) network, a wireless network, a telecommunications network, or the like.

The telecommunications network 190 may be a telephone network that connects telephone devices. For example, the telecommunications network 190 may be, without limitation, a PSTN, a landline, a VoIP network, or the like.

It should be appreciated that FIG. 1 illustrates a non-limiting example embodiment. While FIG. 1 shows the second computing device 160 connecting to both the network 180 and the telecommunications network 190, thereby implying that the second computing device 160 is a mobile device, in other embodiments, more than one device may be used to perform the functions of the second computing device 160. For example, the second computing device 160 may be a desktop computer connected to the network 180 and a second telephone device associated with the desktop computer may connect to the telecommunications network 190.

As will be described in more detail, the computer system 110 and/or the telephony system 120 may field or otherwise handle voice call sessions and may perform operations to authenticate an account holder or computing device prior to or during a voice call session. The voice call sessions may be initiated within an application installed on, for example, the first computing device 140, or may be initiated outside of an application such as for example by using a built-in dialer or calling function resident on the first computing device 140 or by using the telephone device 150. The computer system 110 and/or the telephony system 120 may route the voice call session to the second computing device 160. Further, the computer system 110 may send authentication details of the first computing device 140, such as a one-time password, to the second computing device 160 or vice versa.

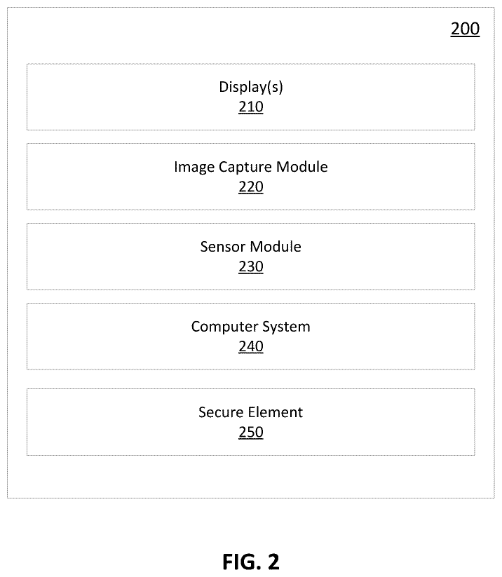

FIG. 2 is a simplified schematic diagram showing components of an exemplary computing device 200. The first computing device 140 and/or the second computing device 160 may be of the same type as the computing device 200 (see FIG. 1). The computing device 200 may include modules including, as illustrated, for example, one or more displays 210, an image capture module 220, a sensor module 230, a computer system 240, and a Secure Element 250.

The one or more displays 210 are a display module. The one or more displays 210 are used to display screens of a GUI that may be used, for example, to communicate with the computer system 110 (see FIG. 1). The one or more displays 210 may be internal displays of the computing device 200 (e.g., disposed within a body of the computing device).

The image capture module 220 may be or may include a camera. The image capture module 220 may be used to obtain image data, such as images. The image capture module 220 may be or may include a digital image sensor system such as, for example, a charge coupled device (CCD) or a complementary metal-oxide-semiconductor (CMOS) image sensor.

The sensor module 230 may be a sensor that generates sensor data based on a sensed condition. By way of example, the sensor module 230 may be or include a location subsystem which generates location data indicating a location of the computing device 200. The location may be the current geographic location of the computing device 200. The location subsystem may be or include any one or more of a global positioning system (GPS), an inertial navigation system (INS), a wireless (e.g., cellular) triangulation system, a beacon-based location system (such as a Bluetooth low energy beacon system), or a location subsystem of another type.

By way of further example, the sensor module 230 may include a biometric subsystem which generates biometric data associated with a user of the computing device 200. The biometric subsystem may obtain biometric data that may be used to identify or verify the user based on one or more physical characteristics. The biometric subsystem may include one or more of a fingerprint scanner, a facial recognition camera, an iris scanner, or any other type of biometric sensor configured to capture and process unique biological identifiers of the user.

The computer system 240 is in communication with the one or more displays 210, the image capture module 220, the sensor module 230, and/or the Secure Element 250. The computer system 240 may be or may include a processor which is coupled to the one or more displays 210, the image capture module 220, and/or the sensor module 230.

The Secure Element 250 is a dedicated, tamper-resistant part of the computing device 200 that is configured to store sensitive data securely. The Secure Element 250 may be isolated from other systems of the computing device 200 making it resistant to hacking of unauthorized users. The Secure Element may be configured to manage cryptographic keys used for authentication, payments, and other sensitive processes.

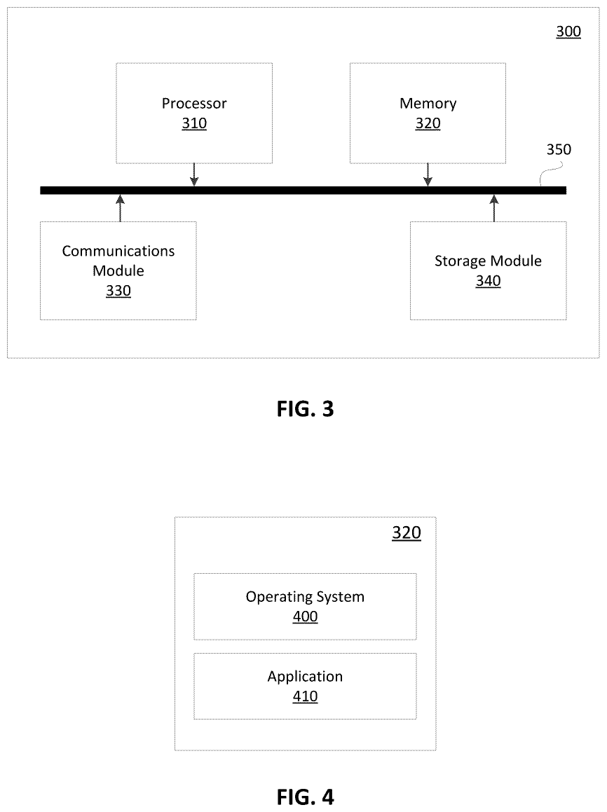

Referring now to FIG. 3, a high-level operation diagram of an example computer system 300 is shown. In some embodiments, the computer system 300 may be exemplary of the computer system 110, the telephony system 120, and/or the computer system 240 (see FIGS. 1 and 2).

The example computer system 300 includes a variety of modules. For example, as illustrated, the example computer system 300 may include a processor 310, a memory 320, a communications module 330, and/or a storage module 340. As illustrated, the foregoing example modules of the example computer system 300 are in communication over a bus 350.

The processor 310 is a hardware processor. The processor 310 may, for example, be one or more ARM, Intel x86, PowerPC processors or the like.

The memory 320 allows data to be stored and retrieved. The memory 320 may be a non-transitory computer-readable medium. The memory 320 may include, for example, random access memory, read-only memory, and persistent storage. Persistent storage may be, for example, flash memory, a solid-state drive or the like. Read-only memory and persistent storage are non-transitory computer-readable storage mediums.

The communications module 330 allows the example computer system 300 to communicate with other computer or computing devices and/or various communications networks. For example, the communications module 330 may allow the example computer system 300 to send or receive communications signals. Communications signals may be sent or received according to one or more protocols or according to one or more standards. For example, the communications module 330 may allow the example computer system 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the example computer system 300 to communicate using near-field communication (NFC), via Wi-Fi (TM), using Bluetooth (TM) or via some combination of one or more networks or protocols. In some embodiments, all or a portion of the communications module 330 may be integrated into a component of the example computer system 300. For example, the communications module may be integrated into a communications chipset. In some embodiments, the communications module 330 may be omitted such as, for example, if sending and receiving communications is not required in a particular application.

The storage module 340 allows the example computer system 300 to store and retrieve data. In some embodiments, the storage module 340 may be formed as a part of the memory 320 and/or may be used to access all or a portion of the memory 320. Additionally or alternatively, the storage module 340 may be used to store and retrieve data from persisted storage other than the persisted storage (if any) accessible via the memory 320. In some embodiments, the storage module 340 may be used to store and retrieve data in a database. A database may be stored in persisted storage. Additionally or alternatively, the storage module 340 may access data stored remotely such as, for example, as may be accessed using a local area network (LAN), wide area network (WAN), personal area network (PAN), and/or a storage area network (SAN). In some embodiments, the storage module 340 may access data stored remotely using the communications module 330. In some embodiments, the storage module 340 may be omitted and its function may be performed by the memory 320 and/or by the processor 310 in concert with the communications module 330 such as, for example, if data is stored remotely. The storage module may also be referred to as a data store.

Software comprising instructions is executed by the processor 310 from a computer-readable medium. For example, a software may be loaded into random-access memory from persistent storage of the memory 320. Additionally or alternatively, instructions may be executed by the processor 310 directly from read-only memory of the memory 320.

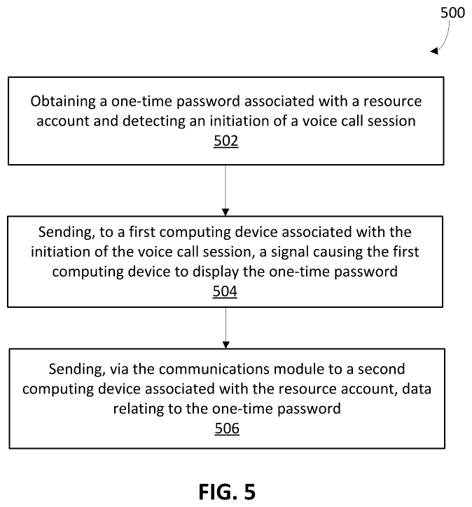

FIG. 4 depicts a simplified organization of software components stored in the memory 320 of the example computer system 300 (see FIG. 3). As illustrated, these software components include an operating system 400 and an application 410.

The operating system 400 is software. The operating system 400 allows the application 410 to access the processor 310 the memory 320, and the communications module 330 of the example computer system 300 (see FIG. 3). The operating system 400 may be, for example, Google ™ Android ™, Apple ™ iOS ™, UNIX ™, Linux ™, Microsoft ™ Windows ™, Apple OSX ™, or the like.

The application 410 adapts the example computer system 300, in combination with the operating system 400, to operate as a device performing a particular function. For example, the application 410 may cooperate with the operating system 400 to adapt a suitable embodiment of the example computer system 300 to operate as the computer system 110, the telephony system 120, and/or the computer system 240 (see FIGS. 1 and 2).

While a single application 410 is illustrated in FIG. 4, in operation the memory 320 may include more than one application 410 and different applications 410 may perform different operations. For example, in at least some embodiments, in which the computer system 300, or a similar system, functions as the first computing device 140, the applications 410 may include an account management application. The account management application may be configured for secure communications with the computer system 110 and may provide various account management functions such as, for example, the ability to display a quantum value in one or more data records, configure or request that operations such as data transfers be performed, and other account management functions.

By way of another example, in at least some embodiments in which the computer system 300, or a similar system, functions as the first computing device 140, the applications 410 may include a telephony application that enables the telephony system 120 to monitor telephony events related to the first computing device 140 or an associated telephone device such as the telephone device 150. In these embodiments, the computer system 110 may, being integrated with the telephony system 120 via CTI technology, and in response to detecting the first computing device 140 initiating a voice call session to the second computing device 160, obtain a one-time password. Further, the computer system 110 may, within the account management application, cause the first computing device 140 to present the one-time password.

In embodiments in which the computer system 300, or a similar system, functions as the second computing device 160, the applications 410 may include a banking application. The banking application may be configured for secure communications with the computer system 110 and may provide various banking functions such as, for example, the ability to display a quantum value in one or more data records (e.g., display balances), configure or request that operations such as transfers of value (e.g., bill payments, email money transfers and other transfers) be performed, and other account management functions. For example, the banking application may be configured to authenticate the user to authorize a transfer request that defines a transfer amount and to define instructions based on session definition data.

By way of further example, in at least one embodiment in which the computer system 300 functions as the second computing device 160 and the applications 410 function as the apps 170, the applications 410 may include a web browser, which may also be referred to as an Internet browser (see FIG. 1). In at least some such embodiments, computer system 110 may be a web server. The web server may cooperate with the web browser and may serve as an interface when the interface is requested through the web browser. For example, the web browser may serve as a mobile banking interface. The mobile banking interface may provide various banking functions such as, for example, the ability to display a quantum of value in one or more data records (e.g., display balances), configure or request that operations such as transfers of value (e.g. bill payments and other transfers) be performed, and other account management functions. For example, the banking interface may be configured to authenticate the user to authorize a transfer request that defines a transfer amount and to define instructions based on session definition data.

The computer system 110 may provide an application or mobile application that, when downloaded on the second computing device 160, may enable communication between the computer system 110 and the second computing device 160. Specifically, when an application is opened and/or used on the second computing device 160, the second computing device 160 may communicate with the computer system 110 and this may be done to perform one or more actions. Additionally or alternatively, an application running or executing on the second computing device 160 (perhaps as a background process) may allow the second computing device 160 to receive messages or push notifications from the computer system 110. In some embodiments, an application installed on the second computing device 160 may cause a message or push notification received from the computer system 110 to appear in a notifications center of the second computing device 160.

In one or more embodiments, once the application has been installed and opened on the second computing device 160, a configuration process may be performed that may require an account holder to authenticate using authentication credential such as, for example, a username, password, passkey, biometric data, or a combination thereof. The computer system 110 may receive the authentication credentials and may confirm that the authentication credentials are correct by consulting, for example, the database 130 (see FIG. 1). In response, the computer system 110 may identify an account of the account holder.

Within the application, the computer system 110 may, in response to detecting, from the telephony system 120, a voice call session initiated by the telephone device 150 to the second computing device 160, cause the second computing device 160 to present a one-time password that may be used to authenticate the telephone device 150, the first computing device 140, or an agent or operator associated with the telephone device 150 or the first computing device 140 (see FIG. 1). Further, the computer system 110 may cause the second computing device 160 to present a selectable interface allowing the account holder or the second computing device 160 to indicate confirmation or authentication of the first computing device 140.

In some embodiments, the computer system 110 may generate the one-time password in response to detecting initiation of the voice call session. In such embodiments, the computer system 110 may generate the one-time password using a random number generator. In some embodiments, the one-time password may be stored in a database such as the database 130. In such embodiments, the computer system 110 may delete the one-time password from the database 130 in response to an expiration condition. An expiration condition may be, for example, termination of the voice call session, reception of a signal from the second computing device 160 indicating confirmation or authentication of the first computing device 140, or a time-based expiry.

In some embodiments, the one-time password may have a time-based expiry. For example, the computer system 110 may periodically generate a one-time password in association with the second computing device 160 or an account associated with the second computing device 160. The computer system 110 may store the one-time password in the database 130. Upon a predetermined amount of time elapsing (for example 30 seconds), the computer system 110 may generate and store a new one-time password in association with the second computing device 160.

In some embodiments, within the application installed on the second computing device 160, the computer system 110 may, in response to at least detecting initiation of a voice call session from the first computing device 140 to the second computing device 160, cause the second computing device 160 to present a GUI allowing the account holder to input a one-time password. The computer system 110 may then cause, via a second application installed on the first computing device 140, the first computing device 140 to present the one-time password.

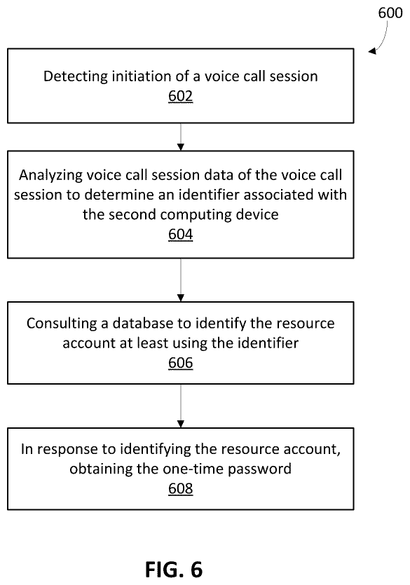

Reference is now made to FIG. 5 which illustrates, in flowchart form, a method 500 for using a one-time password to authenticate a first computing device and/or second computing device. The method 500 may be implemented by a computing device having suitable processor-executable instructions for causing the computing device to carry out the described operations. The method 500 may be implemented, in whole or in part, by at least one processor of the computer system 110, the telephony system 120, or a combination thereof. The computer system 110 may off-load some operations of the method 500 to the first computing device 140 or the second computing device 160 (see FIG. 1).

The method 500 includes obtaining a one-time password associated with a resource account and detecting an initiation of a voice call session (step 502). In an example embodiment, the telephony system 120 may log voice call data, such as an initiation of a voice call session, to the database 130 (see FIG. 1). In this example embodiment, the computer system 110 may monitor voice call data in the database 130 and detect an initiation of the voice call session after the telephony system 120 logs the initiation of the voice call session to the database 130. In this example embodiment, the telephony system 120 may log the initiation of the voice call session and the computer system 110 may detect the initiation of the voice call session in real-time. In another example embodiment, responsive to detecting or logging the initiation of the voice call session, the telephony system 120 may send at least one signal to the computer system 110 wherein the signal indicates that the voice call session has been initiated. The at least one signal may further communicate, to the computer system 110, a caller ID or identifier and a callee ID or identifier. In some embodiments, the caller identifier may correspond to or be associated with the first computing device 140. Likewise, in some embodiments, the callee identifier may correspond to or be associated with the second computing device 160. In at least one embodiment, an API may facilitate communication between the computer system 110 and the telephony system 120.

With respect to obtaining the one-time password, in some embodiments, the computer system 110 may obtain the one-time password from a database such as the database 130. For example, as will be described in herein, the computer system 110 and/or the telephony system 120 may determine from voice call session data of the voice call session an identifier (such as a caller ID, telephone number, or account identifier) that is associated with a resource account. The one-time password may be stored in association with the resource account in the database 130. In some embodiments, the computer system 110 may obtain the one-time password by generating the one-time password. The computer system 110 may generate the one-time password using a random number generator. Further, in at least one embodiment, the computer system 110 may obtain the one-time password in response to detecting the initiation of the voice call session. In some embodiments, the first computing device 140, or the telephone device 150, may initiate the voice call session to the second computing device 160 (see FIG. 1).

Further, in at least one embodiment, the computer system 110 may generate the one-time password based on user input received from the first computing device 140. For example, in response to detecting the first computing device 140 initiating the voice call session, the computer system 110 may send a signal causing the first computing device 140 to display an input interface, within an application or via a webpage, enabling the first computing device 140, or operator thereof, to input a one-time password.

In one or more embodiments, obtaining the one-time password associated with the resource account may be automated in response to detecting the initiation of the voice call session. For example, when the initiation of a voice call session is detected, operations may be performed automatically to obtain the one-time password associated with the resource account.

The method 500 includes sending, to a first computing device associated with the initiation of the voice call session, such as the first computing device 140, a signal causing the first computing device to display the one-time password (step 504).

In some embodiments, the computer system 110 and/or the telephony system 120 may determine that the second computing device 160 has answered the voice call session. The computer system 110 may then, responsive to determining that the second computing device 160 has answered the voice call session, send, via a communications module and to the first computing device 140, the signal causing the first computing device to display the one-time password.

In another embodiment, the computer system 110 may receive a signal from the first computing device 140 wherein the signal requests display of the one-time password. For example, the first computing device 140 may display a selectable user interface element wherein selecting the user interface element sends a request to view the one-time password to the computer system 110. An example of the selectable user interface element is a button element that reads “show one-time password.”

The method 500 includes sending, via a communications module and to a second computing device associated with the resource account, such as the second computing device 160, data relating to the one-time password (step 506).

In some embodiments, the computer system 110 and/or the telephony system 120 may determine that the second computing device 160 has answered the voice call session. The computer system 110 may then, responsive to determining that the second computing device 160 has answered the voice call session, send, via a communications module and to the second computing device 160, the signal causing the second computing device to display the data relating to the one-time password.

In some embodiments, the data relating to the one-time password may include the one-time password. For example, the signal causing the second computing device to display the data relating to the one-time password may be a text message that communicates the one-time password. In another example, the signal causing the second computing device to display the data relating to the one-time password may be a push notification communicating the one-time password.

In some embodiments, the data relating to the one-time password may include a message or notification instructing the second computing device 160 to perform an action before displaying the one-time password. For example, the second computing device 160 may receive a text message or push notification instructing the second computing device 160, or an operator thereof, to login to a mobile application such as a mobile application maintained by the computer system 110, to view the one-time password. Additionally or alternatively, the second computing device 160 may receive a message or notification that includes a selectable link. Selecting the link may cause the second computing device 160 to log into a mobile application as described above or cause the second computing device 160 to navigate to a website maintained by, for example, the computer system 110. A page or interface of the mobile application or website may display the one-time password.

Additionally or alternatively, in some embodiments, the one-time password may be defined by the second computing device 160. In such embodiments, the data relating to the one-time password may include a message or notification instructing the second computing device 160, or operator thereof, to login to an application or select a link. As described above, in some embodiments, the application may be maintained by the computer system 110 and likewise, selecting the link may cause the second computing device 160 to open an application or navigate to a website maintained by the computer system 110. The second computing device 160 may, within the application or on a page of the website, display an input interface enabling a one-time password to be generated via user input. In these embodiments, at the step 504, the computer system 110 may receive the one-time password from the second computing device 160 and then, responsive thereto, cause the first computing device 140 to display the one-time password.

Additionally or alternatively, the computer system 110 may send the one-time password, or data relating to the one-time password, to the second computing device 160 via a message box within an application resident on the second computing device 160 and maintained by the computer system 110. In such an embodiment, the second computing device 160 may receive instructions, via an audio data transfer during the voice call session, to log into or open the application to display the one-time password.

In some embodiments, the second computing device 160 may receive a message or notification including the data relating to the one-time password in an application resident thereon or a notifications center.

It should be appreciated that while FIG. 5 illustrates the step 504 being executed prior to the step 506, in some embodiments, the step 504 may execute subsequent to the step 506 or simultaneously with the step 506.

The communication of the one-time password, or data relating to the one-time password, to the first computing device and the second computing device enables the first computing device to authenticate itself to the second computing device. For example, the first computing device 140 may authenticate itself to the second computing device 160 by communicating the one-time password to the second computing device 160 via audio data transfers from the first computing device 140 to the second computing device 160 during the voice call session. Further, in some embodiments, the computer system 110 may receive, via a communications module and from the second computing device 160, a signal confirming authentication of the first computing device 140 during the voice call session using the one-time password. The computer system 110 may, responsive to receiving the signal confirmation authentication, send, to the first computing device 140, a signal causing the first computing device 140 to remove the one-time password from display. Additionally or alternatively, likewise using audio data transfers during the voice call session, the second computing device 160 may authenticate itself to the first computing device 140 using the one-time password.

It should be appreciated that while FIG. 5 illustrates the use of a one-time password, in some embodiments, additional one-time passwords may be used throughout the execution or performance of the method 500. For example, the computer system 110 may execute two threads of processes similar or identical to the method 500. The first process may relate to the first computing device 140 authenticating itself to the second computing device 160 using the one-time password and the second process may relate to the second computing device 160 authenticating itself to the first computing device 140 using another, or second, one-time password.

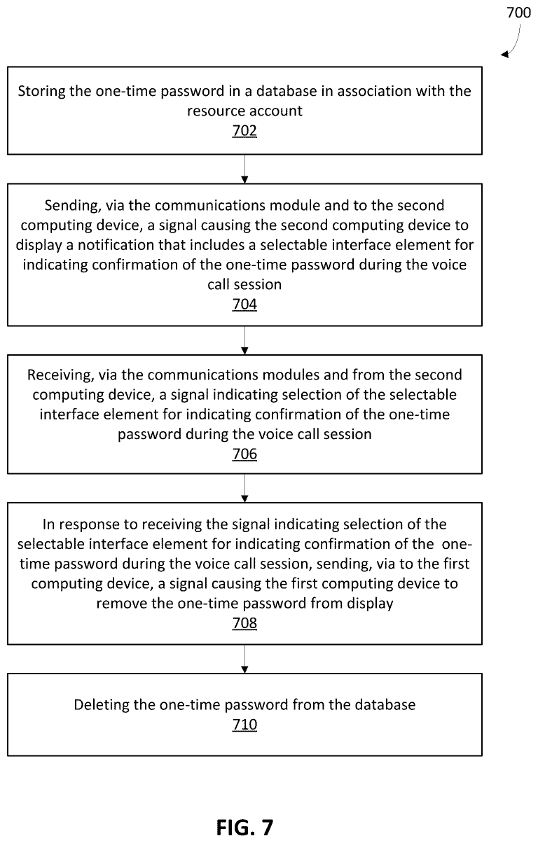

Reference is now made to FIG. 6 which illustrates, in flowchart form, a method 600 for obtaining, from a database, a one-time password or one-time password in association with a resource account. The method 600 may be considered a non-limiting example of the steps or operations included in the step 502 from the method 500 (see FIG. 5). The method 600 may be implemented by a computing device having suitable processor-executable instructions for causing the computing device to carry out the described operations. The method 600 may be implemented, in whole or in part, by at least one processor of the computer system 110, the telephony system 120, or a combination thereof. The computer system 110 may off-load some operations of the method 600 to the first computing device 140 or the second computing device 160 (see FIG. 1).

The method 600 includes detecting initiation of a voice call session (step 602). In at least one embodiment, the computer system 110 or the telephony system 120 may detect that the first computing device 140 initiated a voice call session. This may be performed in manners similar to that described herein with reference to the step 502 of the method 500.

The method 600 includes analyzing voice call session data of the voice call session to determine an identifier associated with a second computing device such as the second computing device 160 (step 604).

In an embodiment, the identifier may be a phone number of or associated with the second computing device 160. The computer system 110 and/or the telephony system 120 may identify the phone number from metadata relating to the voice call session. In another embodiment, the identifier may be a name, first name, surname, or full name, associated with the second computing device 160. For example, subsequent to the voice call session being answered by, for example the second computing device 160, the telephony system 120 may detect from audio data relating to the voice call session, a first name and surname. The computer system 110 may then determine the first name and surname to be the identifier associated with the second computing device. In yet another embodiment, the identifier may be an account identification number or account identifier. For example, the agent or operator associated with the first computing device 140 may, on a GUI displayed on the first computing device 140, select an option such as “call account holder.” Selecting the option may trigger initiation of the voice call session and also cause the computer system 110 to obtain an account identification number associated with a resource account of the account holder.

The method 600 includes consulting a database to identify the resource account at least using the identifier (step 606). For example, the computer system 110 may perform a lookup in the database 130 using the identifier to identify a resource account associated with the identifier (see FIG. 1). For example, in the database 130, without limitation, a telephone number, an account identifier, a full name, or a combination thereof may map to the resource account.

The method 600 includes, in response to identifying the resource account, obtaining the one-time password (step 608). For example, the database 130 may store the one-time password in association with the resource account. Hence, the one-time password may be retrieved or obtained upon identifying the resource account via the identifier in the step 606.

It should be appreciated that while FIG. 6 illustrates a method 600 wherein the one-time password is obtained after identifying the resource account in the database, in other embodiments, the one-time password may be identified in and obtained from the database directly using the identifier. For example, performing a lookup operation in the database 130 using the identifier may enable the computer system 110 to directly identify and retrieve the one-time password.

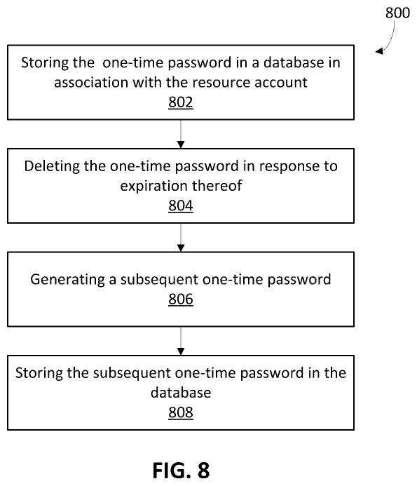

Reference is now made to FIG. 7 which shows, in flowchart form, a method 700 for storing in and deleting from, a database, a one-time password or one-time password associated with a resource account. The method 700 may be implemented by a computing device having suitable processor-executable instructions for causing the computing device to carry out the described operations. The method 700 may be implemented, in whole or in part, by at least one processor of the computer system 110, the telephony system 120, or a combination thereof. The computer system 110 may off-load some operations of the method 700 to the first computing device 140 or the second computing device 160 (see FIG. 1).

The method 700 includes storing the one-time password in a database in association with a resource account (step 702). In some embodiments, the computer system 110 may generate the one-time password in response to detecting an initiation of a voice call session from a first computing device, such as the first computing device 140, to a second computing device such as the second computing device 160. The computer system 110 may generate the one-time password in manners similar to that described with reference to the step 502 of the method 500.

The method 700 includes sending, via a communications module and to a second computing device associated with the resource account, such as the second computing device 160, a signal causing the second computing device to display a notification that includes a selectable interface element for indicating confirmation of the one-time password during the voice call session (step 704). The computer system 110 may also send a signal causing the second computing device to display the one-time password or otherwise communicate the one-time password to an account holder of the resource account and/or operator of the second computing device. The computer system 110 may also simultaneously send another signal to the first computing device and thereby cause the first computing device to display the one-time password.

In some embodiments, the signal may cause the second computing device 160 to display the notification within an application maintained or hosted by, for example, the computer system 110. Additionally or alternatively, the signal may cause the second computing device 160 to navigate to a webpage maintained or hosted by the computer system 110 wherein the webpage displays the notification. In some embodiments, the selectable interface element may be a button. In other embodiments, the selectable interface element may be a confirmation slider.

It should be appreciated that, in some embodiments, the step 704 may be considered a component step of the step 506 (see FIG. 5). That is, in some embodiments, sending the data relating to the one-time password to the second computing device may include sending the signal causing the second computing device to display a notification that includes a selectable interface.

The method 700 includes receiving, via the communication module and from the second computing device, a signal indicating selection of the selectable interface element for indicating confirmation of the one-time password during the voice call session (step 706). For example, a user may select the selectable interface element by performing a tap, double-tap, swipe, or finger slide gesture on a display screen of the second computing device 160 at a location that corresponds to the location of the selectable interface element. Additionally or alternatively, a user may select the selectable interface element by using a cursor to click or double click the selectable interface element in a GUI. The selection of the selectable interface element may cause the second computing device 160 to transmit, to the computer system 110, a signal indicating confirmation of the one-time password. In some embodiments, during a voice call session, prior to the second computing device selecting the interface element to indicate confirmation of the one-time password, the first computing device may authenticate itself to the second computing device by communicating the one-time password to the second computing device via audio communication, audio communication data an audio transfer, or audio transfer data.

The method 700 includes, in response to receiving the signal indicating selection of the selectable interface element for indicating confirmation of the one-time password during the voice call session, sending, via to the first computing device, a signal causing the first computing device to remove the one-time password from display (step 708).

The method 700 includes deleting the one-time password from the database (step 710). For example, in response to receiving the signal indicating selection in the step 706, the computer system 110 may remove the one-time password from a data record associated with the resource account. In some embodiments, the computer system 110 may identify the resource account from an identifier contained in the signal indicating selection or metadata associated therewith. For example, the signal indicating selection or the metadata associated therewith may contain an IP address or account identifier that the computer system 110 can use to identify the resource account by performing a lookup operation in the database 130.

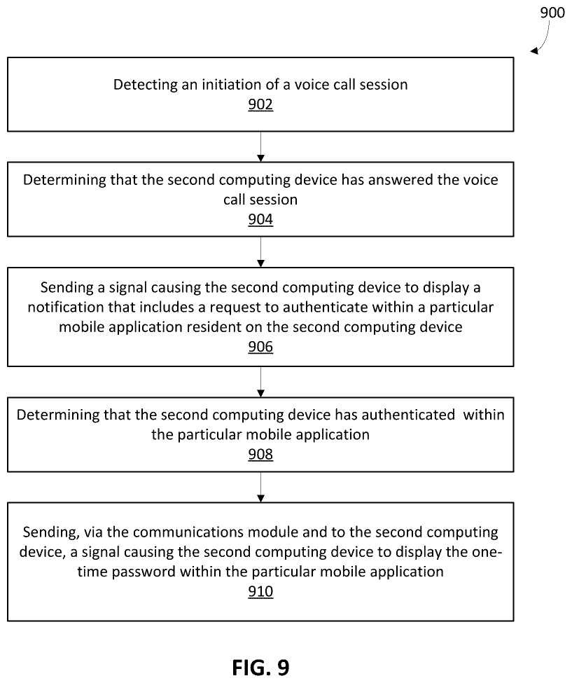

Reference is now made to FIG. 8 which illustrates, in flowchart form, a method 800 for recurrently storing and deleting one-time passwords in a database. The method 800 may be implemented by a computing device having suitable processor-executable instructions for causing the computing device to carry out the described operations. The method 800 may be implemented, in whole or in part, by at least one processor of the computer system 110, the telephony system 120, or a combination thereof. The computer system 110 may off-load some operations of the method 800 to the first computing device 140 or the second computing device 160 (see FIG. 1).

The method 800 includes storing a one-time password in a database in association with the resource account (step 802). As described with reference to the step 502 of the method 500, in some embodiments, the computer system 110 may generate the one-time password or receive the one-time password from the second computing device 160 (see FIG. 5). Responsive thereto, the computer system 110 may store the one-time password in association with resource account in the database 130 (see FIG. 1).

In one or more embodiments, the database 130 may store the one-time password until the computer system 110 detects an expiration such as a time-based expiration (e.g. 30 seconds, 1 minute, 5 minutes) or an expiration trigger (e.g. receiving a signal causing expiration).

The method 800 includes deleting the one-time password in response to expiration thereof (step 804). In some embodiments, the expiration may be triggered by receiving a signal from a computing device such as in the case of the step 706 of the method 700 (see FIG. 7). Additionally or alternatively, the expiration may be triggered by a termination of a voice call session. For example, the computer system 110 may generate the one-time password in association with a resource account and a voice call session initiated by the first computing device 140 to the second computing device 160, the voice call session relating to the resource account. In this example, the first computing device 140 authenticates itself to the second computing device 160 using the one-time password during the voice call session. Following termination of the voice call session, the computer system 110 may delete the one-time password from the database 130.

In other embodiments, as described with reference to the step 802, the expiration of the one-time password may be time-based. For example, the computer system 110 may periodically generate, store, and delete a one-time password. The first computing device 140 may obtain the currently stored one-time password to authenticate itself to the second computing device 160. In such embodiments, the one-time password may expire after a predefined amount of time (e.g. 30 seconds).

In some embodiments, expiry of the one-time password may depend on time, authentication during a voice call session, and termination of a voice call session. For example, the computer system 110 may, by default, delete, generate, and store a one-time password in 30-second intervals. The computer system 110 may deviate from this periodic generation, deletion, and storing of one-time passwords in relation to voice call sessions. For example, receiving an indication of selection of a confirmation interface element on the second computing device 160 or detecting termination of the voice call session may cause the computer system 110 to begin a new cycle of deleting, generating, and storing one-time passwords even if 30 seconds has not elapsed since generating a current one-time password.

The method 800 includes generating a subsequent one-time password (step 806). In some embodiments, the computer system 110 may generate the subsequent one-time password in response to detecting the expiration of the one-time password. In some embodiments, the computer system 110 may generate the subsequent one-time password using a random number generator.

The method includes storing the subsequent one-time password in the database (step 808). In some embodiments, the step 808 may be considered a similar or identical step to the step 802 for the subsequent one-time password. Further, in some such embodiments, the method 800 may execute in a loop that iterates over one-time passwords. In some embodiments, the loop may iterate a predefined amount of times (e.g. once per hour, 6 times per day, 10 times per week).

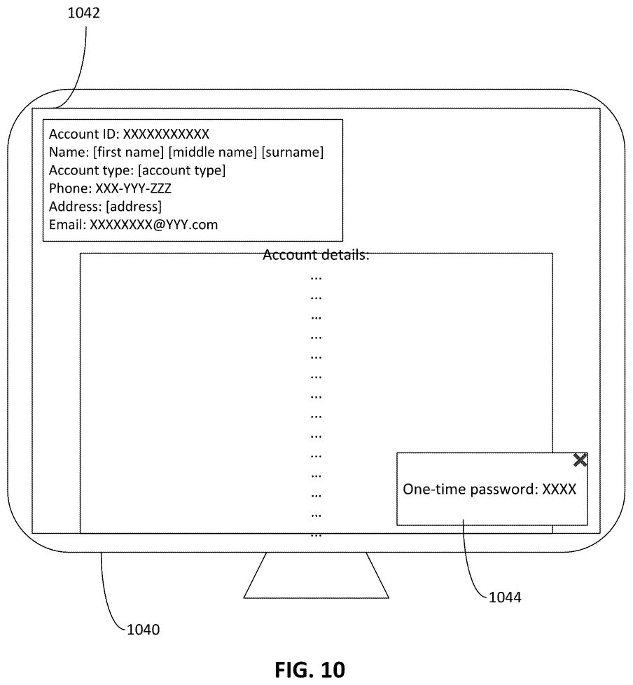

Reference is now made to FIG. 9 which illustrates, in flowchart form, a method 900 for displaying a one-time password on a computing device via a mobile application installed thereon. The method 900 may be considered, at least partially, a non-limiting example embodiment of the steps and operations that may be included in the step 506 from the method 500 (see FIG. 5). The method 900 may be implemented by a computing device having suitable processor-executable instructions for causing the computing device to carry out the described operations. The method 900 may be implemented, in whole or in part, by at least one processor of the computer system 110, the telephony system 120, or a combination thereof. The computer system 110 may off-load some operations of the method 900 to the first computing device 140 or the second computing device 160 (see FIG. 1).

The method 900 includes detecting an initiation of a voice call session (step 902). This may be done in manners similar to that described herein with reference to the step 502 of the method 500 (see FIG. 5). In some embodiments, the first computing device 140 may initiate the voice call session to the second computing device 160 in association with a resource account.

The method 900 includes determining that the second computing device has answered the voice call session (step 904). For example, the telephony system 120 may log that the second computing device 160 has answered the voice call session. The telephony system 120 may then log that the second computing device 160 has answered the voice call session to, for example, the database 130 (see FIG. 1). The computer system 110 may monitor the database 130, and responsive to the telephony system 120 logging the answering of the second computing device 160, determine, in real-time, that the second computing device 160 answered the voice call session. Additionally or alternatively, the telephony system 120 may, responsive to detecting the second computing device 160 answering the voice call session, send a signal to the computer system 110 wherein the signal indicates to the computer system 110 that the second computing device 160 has answered the voice call session.

The method 900 includes, responsive to determining that the second computing device has answered the voice call session, sending, via a communications module and to the second computing device, a signal causing the second computing device to display a notification that includes a request to authenticate within a particular mobile application resident on the second computing device (step 906). For example, the computer system 110 may send a signal to the second computing device 160 wherein the signal causes the second computing device 160 to display a push notification requesting to authenticate within a particular mobile application resident on the second computer device 160. In particular, in some embodiments, the link, when selected, may cause the second computing device 160 to navigate to a login page within the mobile application. Logging into the mobile application may cause the second computing device 160 to display the one-time password within the mobile application. Additionally or alternatively, in the event that the second computing device 160 is already logged into the mobile application (i.e. the mobile application “remembers” the second computing device 160), selecting the link may cause the second computing device 160 to navigate to a page displaying the one-time password. In another embodiment, the telephony system 120 may send a text message to the second computing device 160 wherein the text message requests to authenticate within a particular mobile application. Further, the computer system 110 and/or the telephony system 120 may send the signal, notification, and/or message to the second computing device 160 in real-time. That is, the second computing device 160 answering the voice call session and receiving the signal, message, and/or notification may be simultaneous or near-simultaneous.

The method 900 includes determining that the second computing device has authenticated within the particular mobile application (step 908). In some embodiments, the second computing device 160 may authenticate within the particular mobile application using a username, password, biometric data such as a face scan or thumbprint, or a combination thereof. Further, in some embodiments, the computer system 110 may receive, via a communications module and from the second computing device 160, authentication data. The computer system 110 may analyze the authentication data to identify the resource account. Identifying the resource account may thereby enable the computer system 110 to obtain a one-time password from a database.

The method 900 includes sending, via a communications module and to the second computing device, a signal causing the second computing device to display the one-time password within the particular mobile application (step 910). In some embodiments, the signal causing the second computing device to display the one-time password within the particular mobile application may include a push notification. For example, the computer system 110 may send a push notification to the second computing device 160 wherein selecting the push notification causes the second computing device 160 to display the one-time password. In some embodiments, the signal may, similar to the step 704 of the method 700, cause a selectable interface element to be displayed within the particular mobile application, wherein selecting the interface element causes the second computing device 160 to send a confirmation signal to the computer system 110 (see FIG. 7).

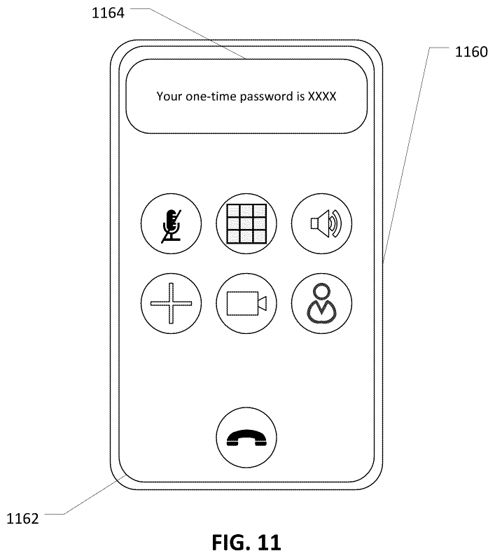

Reference is now made to FIG. 10 which shows an example computing device 1040, or its monitor, displaying a one-time password with respect to a voice call session. The computing device 1040 may correspond to the first computing device 140 (see FIG. 1). That is, the computing device 1040 may have initiated a voice call session to a second computing device, such as the second computing device 160.

FIG. 10 shows the computing device 1040 displaying a user interface 1042. The user interface 1042 is shown displaying account profile information and account details with respect to a resource account. The resource account may be associated with the second computing device 160.

FIG. 10 further shows a pop-up window 1044 appearing in the user interface 1042. The pop-up window 1044 displays a one-time password or one-time password. In some embodiments, the pop-up window 1044 may be displayed in response to receiving a signal from the computer system 110 that, similar to the signal in the step 504 of the method 500, causes the computing device 1040 to display the one-time password.

While FIG. 10 shows a pop-up window 1044 that appears to be selectively closed by the computing device 1040, in other embodiments, the computing device 1040 may not be permitted to selectively close the pop-up window 1044. For example, the computer system 110 may control the display of the one-time password. The computer system 110 may send a signal causing the computing device 1040 to close the pop-up window 1044 upon receiving a confirmation signal with respect to the one-time password from, for example, the second computing device 160.

While FIG. 10 shows the one-time password being displayed in the pop-up window 1044, other embodiments may use alternative means to display the one-time password. For example, the user interface 1042 may have the one-time password displayed in the account profile information section, the account details section, or another section within the user interface 1042.

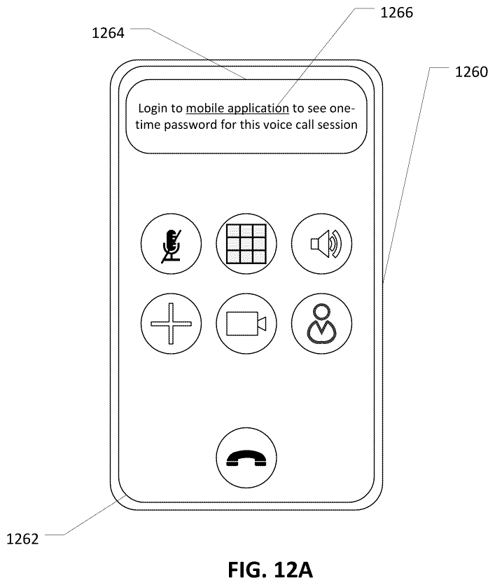

Reference is now made to FIG. 11 which shows a computing device 1160 displaying a message or notification displaying a one-time password related to a voice call session. In some embodiments, the computing device 1160 may correspond to the second computing device 160 (see FIG. 1). For example, the computing device 1160 may have answered a voice call session initiated by the first computing device 140.

FIG. 11 shows the computing device 1160 having a display 1162. The display 1162 is displaying a GUI associated with a voice call session. FIG. 11 further shows the display 1162 presenting a message or notification 1164 wherein the message or notification 1164 presents the one-time password. In some embodiments, similar to the step 506 of the method 500, the computing device 1160 may display the message or notification 1164 in response to receiving, from the computer system 110, data relating to the one-time password (see FIG. 5).

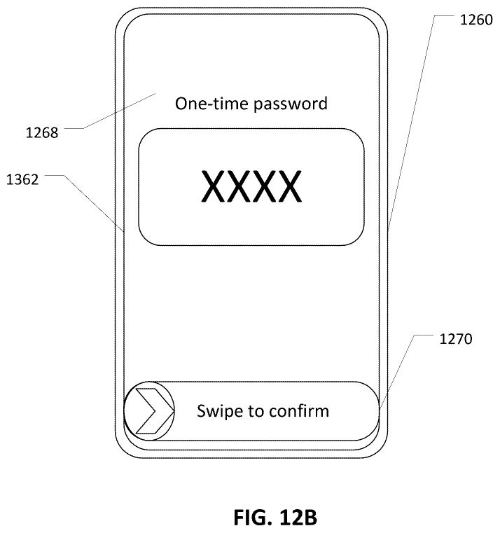

Reference is now made to FIG. 12A which shows another computing device 1260 displaying a message or notification displaying data related to a one-time password related to a voice call session. In some embodiments, the computing device 1260 may correspond to the second computing device 160 (see FIG. 1). For example the computing device 1260 may have answered a voice call session initiated by the first computing device 140.

Similar to the computing device 1160 in FIG. 11, the computing device 1260 has a display 1262 displaying a GUI associated with a voice call session and a message or notification 1264. The message displayed on the computing device 1260 differs from the message displayed on the computing device 1160 in that the message or notification 1264 displays, instead of the one-time password, instructions to login to a mobile application resident on the computing device 1260 in order to view the one-time password. In some embodiments, similar to the step 506 of the method 500, the computing device 1260 may display the message of notification 1264 in response to receiving, from the computer system 110, data relating to the one-time password (see FIG. 5).

The message or notification 1264 is further shown including a selectable element 1266. Selecting the selectable element 1266 may, as described with reference to the step 906 of the method 900, cause the computing device 1260 to display a login page for the mobile application (see FIG. 9).

Reference is now made to FIG. 12B which illustrates the computing device 1260 displaying the one-time password displayed within the mobile application. The display 1262 is shown displaying a page 1268 that displays the one-time password. The display 1262 may, as described herein with reference to the steps 906 to 908 of the method 900, proceed to display the page 1268 after the computing device 1260 logs into the mobile application (see FIG. 9). The page 1268 further includes a confirmation slider 1270. Selecting or sliding the confirmation slider 1270 may, similar to the step 706 of the method 700, cause the computing device 1260 to send a confirmation signal to the computer system 110 (see FIG. 7).

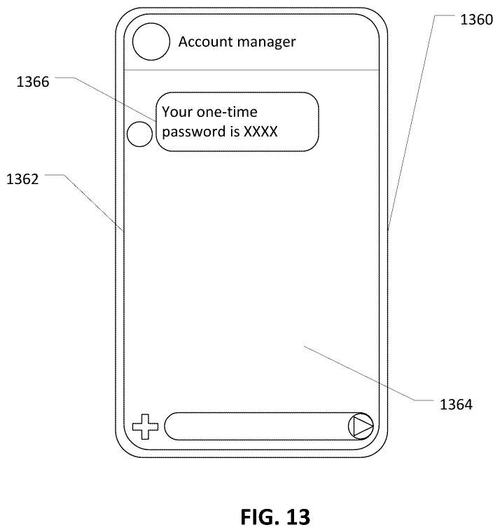

Reference is now made to FIG. 13 which illustrates a computing device 1360 displaying a text message 1366 containing a one-time password within a resident messaging application. The computing device 1360 has a display 1362 showing a chat 1364. The text message 1366 is shown within the chat 1364. In some embodiments, similar to the step 506 of the method 500, the computing device 1360 may display the text message 1366 in response to receiving, from the computer system 110 or the telephony system 120, data relating to the one-time password (see FIG. 5). In some embodiments, the telephony system 120 may send, using short message service (SMS), the text message 1366 to the computing device 1360. In other embodiments, the computer system 110 may send the text message 1366 the computing device 1360 using an Internet protocol.

In conventional voice call session authentication, the calling party typically requests the answering party to authenticate themselves by responding to personal questions or other verification methods. However, such approaches often leave the calling party's identity unchecked, increasing the risk of fraudulent activities. At least some of the embodiments described herein address this limitation by enabling the answering party to authenticate the calling party. This reversal of conventional roles introduces an additional layer of security, significantly mitigating fraud risks and enhancing trust during voice call interactions.

In manners described herein, the first computing device 140, or initiator of a voice call session, may authenticate itself to the second computing device 160, or receiver of a voice call session, using a one-time password and vice versa. As such, the second computing device 160 may require minimal resources to confirm the identity of the first computing device 140. For example, typical security measures with respect to voice call sessions include checking an origin of the voice call session for suspicious or fraudulent activity and checking to see if the origin of the voice call session matches an expected origin of the voice call session. These methods can often be computationally intensive. Further, such methods can be compromised if a bad actor can make a voice call session appear to originate from an expected origin that is not the bad actor. In the manner described herein, the second computing device 160 merely waits to receive, from the computer system 110, a one-time password or data relating to a one-time password in a mobile application maintained by the computer system 110 or a computer or server otherwise associated with the computer system 110. Thus, the second computing device 160 can confirm the identity of the first computing device 140 in a computationally inexpensive manner. Moreover, a bad actor making a voice call session appear to originate from a source different from the bad actor has no effect on whether the computer system 110 will send data relating to a one-time password to the second computing device 160. Thus, the manners described herein provide a security measure that is resistant to tampering by bad actors. The first computing device 140 can likewise confirm the identity of the second computing device 160 using a computationally inexpensive method that reduces the likelihood of fraud.

In the manners described herein, in some embodiments where the initiating party is an operator of a financial institution and the answering party is a customer, the customer can ensure the operator is indeed from the financial institution using secure measures that include logging into the mobile application hosted by the financial institution and displaying the one-time password. In this manner, the financial institution can ensure that the customer is indeed the customer as biometrics or other authentication credentials are used to log into the mobile application while at the same time the customer can ensure the operator actually works at the financial institution as the one-time password is generated and sent from the financial institution and displayed within the mobile application. This method of authentication offers security from bad actors attempting to defraud financial institution customers by impersonating a financial institution employee as the bad actors would need to bypass the security of the mobile application to deceive financial institution customers into believing that the bad actors are associated with the financial institution.

Further, conventional methods for confirming or authenticating an identity over or during a voice call session often involves asking and answering personal questions such as address, date of birth, or favorite food. This method of confirmation and authentication has vulnerabilities in that some personal information can be scoured with ease (for example through social media), sometimes the authenticating party can forget the correct answer (e.g. favorite food), the answer may change and the party asking the question may not be updated with respect to the change (e.g. address), and personal information can leak thereby causing a security threat. The systems and methods described herein allow a party to confirm their identity without providing personal information to the confirming party. Hence, the systems and methods described herein offer a more secure and resistant method of confirming identity over or during a voice call session. The systems and methods described herein are more efficient in telecommunication network usage because sending a one-time password to a computing password and receiving a confirmation signal is faster and uses less resources (e.g. network resources) then transferring audio data containing questions and answers relating to personal information.

In conventional voice call session authentication, the calling party typically requests the answering party to authenticate themselves by responding to personal questions or other verification methods. However, such approaches often leave the calling party's identity unchecked, increasing the risk of fraudulent activities. At least some of the embodiments described herein address this limitation by enabling the answering party to authenticate the calling party. This reversal of conventional roles introduces an additional layer of security, significantly mitigating fraud risks and enhancing trust during voice call interactions.

It will be appreciated that one or more of the systems, methods, or processes described herein may be implemented, enhanced, or optimized using artificial intelligence (AI), machine learning (ML), or other advanced computational techniques. AI-based models, including but not limited to neural networks, deep learning architectures, and predictive algorithms, may be employed to automate decision-making, improve efficiency, and adapt dynamically to changing conditions. These AI-driven implementations may be executed in cloud-based environments, edge computing systems, or on-device processors, depending on application requirements. Additionally, AI may facilitate data analysis, pattern recognition, anomaly detection, or autonomous operation, further enhancing the performance and functionality of the disclosed embodiments. For example, at least one of obtaining the one-time password associated with the resource account, sending the signal causing the first computing device to display the one-time password, or sending data relating to the one-time password described herein may be performed using artificial intelligence.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A computer system comprising:
at least one processor;
a communications module coupled to the at least one processor; and
a memory coupled to the at least one processor, the memory storing instructions that, when executed, configure the at least one processor to:
obtain a one-time password associated with a resource account and detect an initiation of a voice call session;
send, to a first computing device associated with the initiation of the voice call session, a signal causing the first computing device to display the one-time password; and
send, via the communications module to a second computing device associated with the resource account, data relating to the one-time password.

2. The computer system of claim 1, wherein the instructions, when executed, further configure the at least one processor to:
receive, via the communications module and from the second computing device, a signal confirming authentication of the first computing device during the voice call session using the one-time password; and
responsive to receiving the signal confirming the authentication, send, to the first computing device, a signal causing the first computing device to remove the one-time password from display.

3. The computer system of claim 1, wherein the instructions, when executed, further configure the at least one processor to:
analyze voice call session data of the voice call session to determine an identifier associated with the second computing device;
consult a database to identify the resource account at least using the identifier; and
in response to identifying the resource account, obtain the one-time password.

4. The computer system of claim 3, wherein the instructions, when executed, further configure the at least one processor to:
determine that the second computing device has answered the voice call session; and
responsive to determining that the second computing device has answered the voice call session, send, via the communications module and to the first computing device, the signal causing the first computing device to display the one-time password.

5. The computer system of claim 1, wherein the instructions, when executed, further configure the at least one processor to:
responsive to detecting the initiation of the voice call session, generate the one-time password; and
store the one-time password in a database in association with the resource account.

6. The computer system of claim 5, wherein the instructions, when executed, further configure the at least one processor to:
send, via the communications module and to the second computing device, a signal causing the second computing device to display a notification that includes a selectable interface element for indicating confirmation of the one-time password during the voice call session;
receive, via the communication module and from the second computing device, a signal indicating selection of the selectable interface element for indicating confirmation of the one-time password during the voice call session;
in response to receiving the signal indicating selection of the selectable interface element for indicating confirmation of the one-time password during the voice call session, send, via to the first computing device, a signal causing the first computing device to remove the one-time password from display; and
delete the one-time password from the database.

7. The computer system of claim 5, wherein the instructions, when executed, further configure the at least one processor to:
delete the one-time password in response to expiration thereof;
generate a subsequent one-time password; and
store the subsequent one-time password in the database.

8. The computer system of claim 1 wherein when sending, to the second computer device, the data relating to the one-time password, the instructions, when executed, further configure the at least one processor to:
determine that the second computing device has answered the voice call session; and
responsive to determining that the second computing device has answered the voice call session, send, via the communications module and to the second computing device, a signal causing the second computing device to display the data relating to the one-time password.

9. The computer system of claim 1, wherein the instructions, when executed, further configure the at least one processor to:
determine that the second computing device has answered the voice call session; and
responsive to determining that the second computing device has answered the voice call session, send, via the communications module and to the second computing device, a signal causing the second computing device to display a notification that includes a request to authenticate within a particular mobile application resident on the second computing device.

10. The computer system of claim 9, wherein the instructions, when executed, further configure the at least one processor to:
determine that the second computing device has authenticated within the particular mobile application; and
send, via the communications module and to the second computing device, a signal causing the second computing device to display the one-time password within the particular mobile application.

11. The computer system of claim 9, wherein the signal causing the second computing device to display the one-time password within the particular mobile application includes a push notification.

12. The computer system of claim 10, wherein the instructions, when executed, further configure the at least one processor to:
receive, via the communications module and from the second computing device, authentication data; and
analyze the authentication data to identify the resource account.

13. The computer system of claim 1, wherein at least one of obtaining the one-time password associated with the resource account, sending the signal causing the first computing device to display the one-time password, or sending data relating to the one-time password is performed using artificial intelligence.

14. A computer-implemented method, the method comprising:
obtaining a one-time password associated with a resource account and detecting an initiation of a voice call session;
sending, to a first computing device associated with the initiation of the voice call session, a signal causing the first computing device to display the one-time password; and
sending, via a communications module to a second computing device associated with the resource account, data relating to the one-time password.

15. The computer-implemented method of claim 14, further comprising:
receiving, via the communications module and from the second computing device, a signal confirming authentication of the first computing device during the voice call session using the one-time password; and
responsive to receiving the signal confirming the authentication, sending, to the first computing device, a signal causing the first computing device to remove the one-time password from display.

16. The computer-implemented method of claim 14, further comprising:
analyzing voice call session data of the voice call session to determine an identifier associated with the second computing device;
consulting a database to identify the resource account at least using the identifier; and
in response to identifying the resource account, obtaining the one-time password.

17. The computer-implemented method of claim 16, further comprising:
determining that the second computing device has answered the voice call session; and
responsive to determining that the second computing device has answered the voice call session, sending, via the communications module and to the first computing device, the signal causing the first computing device to display the one-time password.

18. The computer-implemented method of claim 14, further comprising:
responsive to detecting the initiation of the voice call session, generating the one-time password; and
storing the one-time password in a database in association with the resource account.

19. The computer-implemented method of claim 18, further comprising:
sending, via the communications module and to the second computing device, a signal causing the second computing device to display a notification that includes a selectable interface element for indicating confirmation of the one-time password during the voice call session;
receiving, via the communication module and from the second computing device, a signal indicating selection of the selectable interface element for indicating confirmation of the one-time password during the voice call session;
in response to receiving the signal indicating selection of the selectable interface element for indicating confirmation of the one-time password during the voice call session, sending, via to the first computing device, a signal causing the first computing device to remove the one-time password from display; and
deleting the one-time password from the database.

20. A non-transitory computer-readable medium storing instructions that, when executed by at least one processor, cause the at least one processor to:
obtain a one-time password associated with a resource account and detect an initiation of a voice call session;
send, to a first computing device associated with the initiation of the voice call session, a signal causing the first computing device to display the one-time password; and
send, via a communications module to a second computing device associated with the resource account, data relating to the one-time password.
